(19) United States
(12) Patent Application Publication
(10) Pub. No.: US 2010/0011611 A1
(43) Pub. Date: Jan. 21, 2010

(54) Method for controlling fragrance spray for clothes dryer

(76) Inventors: Min-Ji KIM, Changwon (KR); Sang-Hun BAE, Changwon (KR); Chul-Jin CHOI, Changwon (KR)

Correspondence Address: MCKENNA LONG & ALDRIDGE LLP, 1900 K STREET, NW, WASHINGTON, DC, 20006, US

(21) Appl. No.: 12/458,597

(22) Filed: Jul. 16, 2009

Related U.S. Application Data
(60) Provisional application No. 61/129,780, filed on Jul. 17, 2008.

(30) Foreign Application Priority Data
Jul. 17, 2008 (KR) 10-2008-0069724

(51) Int. Cl. F26B 7/00; F26B 3/00; F26B 3/02

(52) U.S. Cl. 34/390; 34/499; 34/497

(57) ABSTRACT

A method for controlling fragrance spray for a clothes dryer, comprising: a clothes inputting step of inputting an object to be dried into a drum of a clothes dryer; a steam spraying step of spraying steam into the drum of the clothes dryer; a first fragrance spraying step of spraying fragrance into the drum of the clothes dryer during the steam spraying step; and a second fragrance spraying step of spraying fragrance into the drum of the clothes dryer after the steam spraying step has finished. Since fragrance is firstly sprayed into the drum of the clothes dryer while steam is sprayed to the clothes during the drying step. Then, the fragrance is secondarily sprayed into the drum after the steam spraying step has finished. This may allow fragrance to be more effectively deposited onto the clothes inside the drum, and may enhance a drying effect by steam.

### RELATED APPLICATION

The present disclosure relates to subject matter contained in priority Korean Application No. 10-2008-0069724, filed on Jul. 17, 2008 and U.S. Patent Application No. 61/129,780, filed on Jul. 17, 2008, which are herein expressly incorporated by reference in its entirety.

### BACKGROUND OF THE INVENTION

1. Field of the Invention

The present invention relates to a method for controlling a clothes dryer, and more particularly, to a method for controlling a clothes dryer having a fragrance spray device capable of spraying fragrance into a drum of the clothes dryer.

2. Background of the Invention

In general, a clothes dryer indicates an apparatus for drying laundry having completely undergone a dehydration step after a washing step, by introducing the laundry into a drum of the clothes dryer, and by evaporating moisture inside the laundry by supplying hot blast into the drum.

The clothes dryer comprises a drum disposed in the clothes dryer and into which laundry is introduced, a driving motor for driving the drum, a blow fan for blowing air into the drum, and a heating means for heating the air introduced into the drum.

The heating means may use high-temperature electric resistance heat generated by using an electric resistance, or combustion heat generated by combusting gas.

Air having been discharged from the drum contains moisture of the laundry inside the drum, thereby changing into high-temperature humid air. According to a method for processing the high-temperature humid air, the clothes drier may be classified. More concretely, the clothes drier is classified into a condensation type clothes dryer for condensing moisture inside high-temperature humid air by heat-exchanging the high-temperature humid air with external air through circulation in the clothes dryer without discharging the high-temperature humid air out of the clothes dryer, and an exhaustion type clothes dryer for directly discharging high-temperature humid air having passed through the drum to the outside.

In the conventional clothes dryer, laundry is dehydrated with an attached state to an inner circumferential surface of the drum. Accordingly, in order to remove wrinkles and to arrange the laundry in a state for facilitation of ironing, has been used a steam supplier for supplying steam into the drum.

However, the conventional clothes dryer has the following problems.

Firstly, in the case of drying laundry by the clothes dryer, the laundry having been completely washed by a washing machine, moisture included in the laundry is removed. However, odor of washing water or detergent may remain in the dried clothes, or odor remaining on laundry itself prior to the washing step may remain on the dried clothes after the washing step. This may cause a user's discomfort.

Furthermore, this odor may become more severe when laundry having been completely washed stays in the washing machine for a long time without being directly discharged out from the washing machine.

To solve these problems, there has been a need to remove the unpleasant odor, and has been required a method for effectively supplying fragrance to clothes, etc. with consideration of the amount of steam and fragrance.

### SUMMARY OF THE INVENTION

Therefore, an object of the present invention is to provide a method for controlling fragrance spray for a clothes dryer capable of effectively spraying fragrance into an object to be dried, by spraying fragrance into a drum of a clothes dryer during a drying step, so as to remove odor from clothes having been completely dried and to allow fragrance to be emitted from the clothes.

Another object of the present invention is to provide a method for controlling fragrance spray for a clothes dryer capable of effectively spraying fragrance onto clothes to be dried by considering steam supply into a drum and rotation of the drum in a drying step.

To achieve these and other advantages and in accordance with the purpose of the present invention, as embodied and broadly described herein, there is provided a method for controlling fragrance spray for a clothes dryer, comprising: a clothes inputting step of inputting an object to be dried into a drum of a clothes dryer; a steam spraying step of spraying steam into the drum of the clothes dryer; a first fragrance spraying step of spraying fragrance into the drum of the clothes dryer during the steam spraying step; judging whether or not the steam spraying step has been completed by a controller; and a second fragrance spraying step of spraying fragrance into the drum of the clothes dryer after the steam spraying step has finished.

Under these configurations, the fragrance spraying step may be divided into the first and second fragrance spraying steps, thereby more effectively depositing fragrance onto clothes, etc. Furthermore, fragrance may be sprayed onto clothes with the steam spraying step of spraying steam into the drum of the clothes dryer. This may enhance a wrinkle removing function by steam, and allow fragrance to be smoothly deposited onto clothes.

During the steam spraying step, steam is continuously sprayed into the drum of the clothes dryer, and rotation and stopping of the drum is periodically repeated by a driving motor. That is, during the steam spraying step, the drum of the clothes dryer may be periodically rotated. This may enhance a fragrance spraying effect as well as a steam spraying effect. Here, time for which the drum is rotated may be shorter than time for the drum is stopped.

The first fragrance spraying step may be executed during the steam spraying step, whereas the second fragrance spraying step may be executed after the steam spraying step has finished. Here, the first fragrance spraying step may be simultaneously executed upon start of the steam spraying step, or may be periodically executed during the steam spraying step. In the first fragrance spraying step, fragrance may be continuously sprayed for at least one minute.

According to another aspect of the present invention, there is provided a method for controlling fragrance spray for a clothes dryer, comprising: a clothes inputting step of inputting an object to be dried into a drum of a clothes dryer; a steam spraying step of spraying steam into the drum of the clothes dryer; a first fragrance spraying step of spraying fragrance into the drum of the clothes dryer; a temperature measuring step of measuring an inner temperature of the drum; a temperature comparing step of comparing the temperature of the drum measured by a controller with a preset temperature; and a second fragrance spraying step of spraying fragrance into the drum of the clothes dryer.

Under these configurations, the second fragrance spraying step may be executed by judging whether an inner temperature of the drum of the clothes dryer measured after the steam spraying step has finished corresponds to a predetermined temperature. That is, the second fragrance spraying step may be executed when the inner temperature of the drum of the clothes dryer measured in the temperature comparing step is lower than the predetermined temperature. In this case, the preset temperature may be 30° or 40° C. Preferably, the second fragrance spraying step may be continuously executed for at least one minute.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a clothes dryer according to the present invention;

FIG. 2 is a side sectional view of the clothes dryer of FIG. 1;

FIG. 3 is a perspective view of a steam generator mounted to the clothes dryer;

FIG. 4 is a view of a front supporter having a fragrance supplying module according to the present invention;

FIG. 5 is a perspective view of the fragrance supplying module of FIG. 4;

FIG. 6 is a flowchart showing a drying step with fragrance spray according to a first embodiment of the present invention; and

FIG. 7 is a flowchart showing a drying step with fragrance spray according to a second embodiment of the present invention.

### DETAILED DESCRIPTION OF THE INVENTION

Description will now be given in detail of the present invention, with reference to the accompanying drawings.

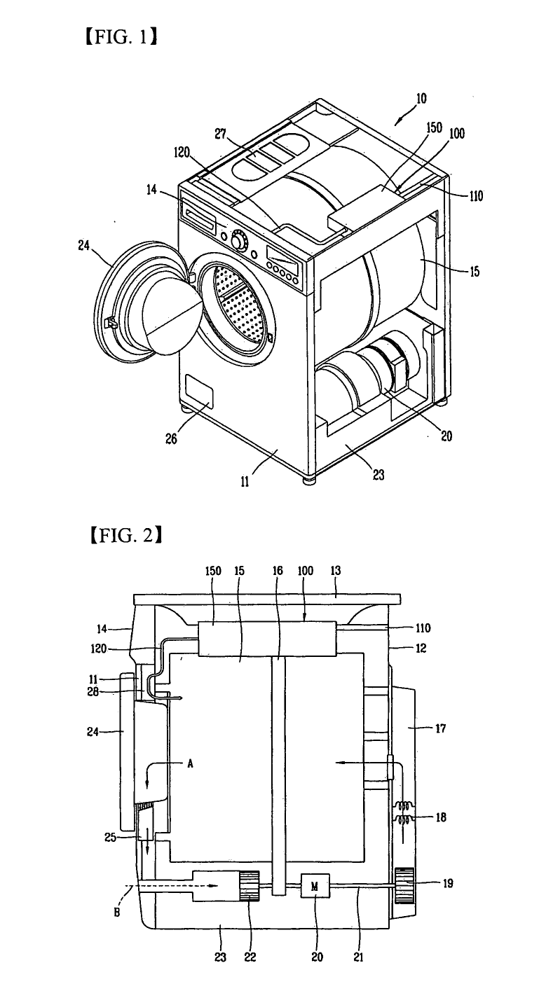

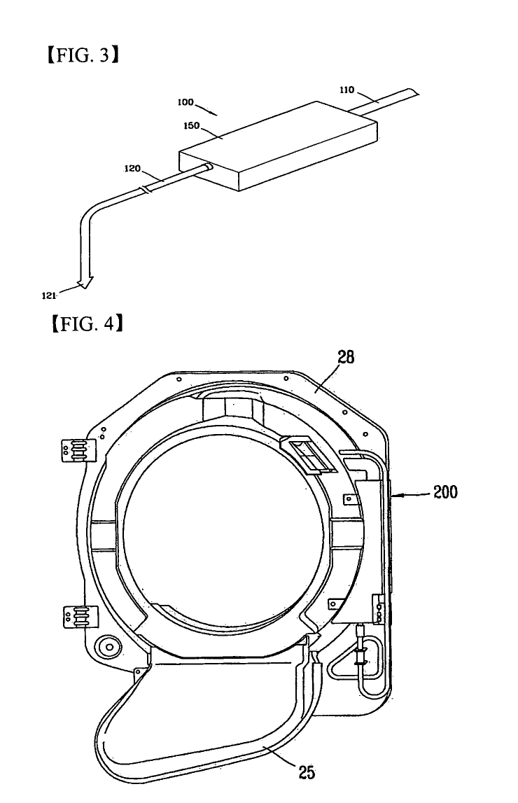

Referring to FIGS. 1 and 2, a clothes dryer 10 according to the present invention comprises a front cover 11, a rear cover 12, a top cover 13, and a drum 15 into which laundry is introduced. The clothes dryer 10 also comprises a front supporter 28 mounted at a rear surface of the front cover 11, for supporting a front opening of the drum 15; a door 24 mounted at a front surface of the front cover 11, for opening and closing an opening of the drum 15; and a control panel 14 disposed at an upper part of the front cover 11, and having each kind of buttons for inputting drying conditions.

Also, the clothes dryer 10 comprises a drying fan 19 for making air inside the drum 15 circulate in the clothes dryer 10, a drying duct 17 for guiding circulation air having passed through the drum 15 by the drying fan 19 to be introduced into the drum 15, a heater 18 disposed in the drying duct 17 for heating air introduced into the drum 15, and a steam generator 100 disposed at an outer side of the drum 15 for generating steam.

Below the drum 15, further comprised are a base 23 having a flow path of circulation air A and a flow path of external air B which performs heat exchange with the circulation air A; a driving motor 20 mounted on an upper part of the base 23 for driving the drum 15; a belt 16 for transmitting a rotation force generated by the driving motor 20 to the drum 15; a cooling fan 22 connected to a motor shaft 21 of the driving motor 20 for sucking indoor air; and a condenser 26 mounted at an inner side of the base 23, for heat-exchanging the external air B with the circulation air A.

FIG. 3 is a perspective view of a steam generator 100 mounted to the clothes dryer 10.

Referring to FIG. 3, the steam generator 100 includes a water supplying hose 110 for supplying water having a room temperature, a steam generator body 150 for storing water supplied thereto, a heater (not shown) disposed in the steam generator body 150 for heating the stored water, a discharge hose 120 for discharging steam generated from the steam generator body 150, and a steam nozzle 121 connected to the end of the discharge hose 120. Under these configurations, water having been supplied to the steam generator body 150 through the water supplying hose 110 is heated by the heater, and then is discharged to the discharge hose 120. And, the discharged steam is sprayed into the drum 15 through the steam nozzle 121.

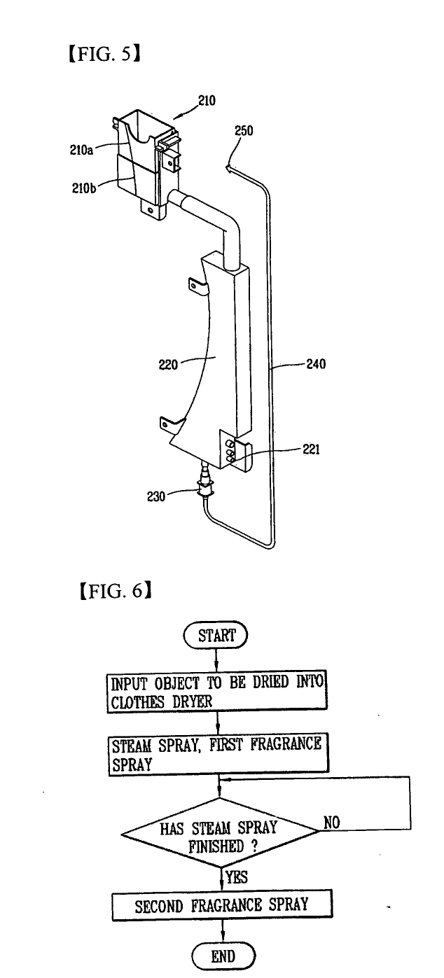

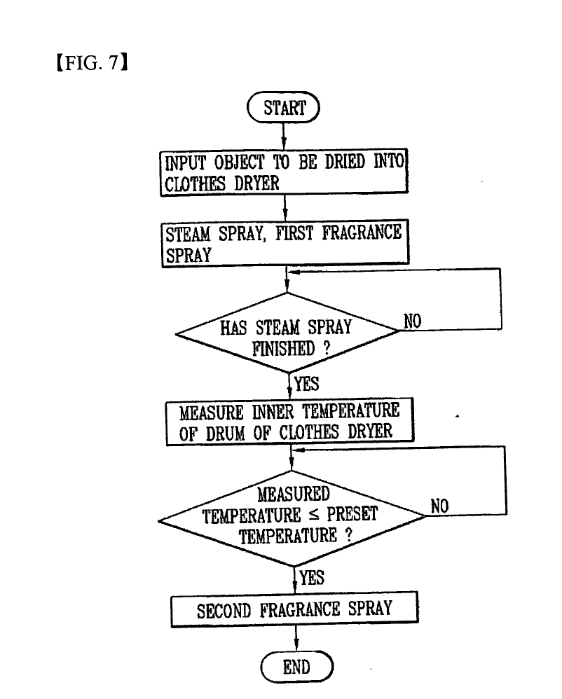

FIG. 4 is a view of the front supporter 28 for supporting a front opening of the drum 15 of the clothes dryer according to the present invention, and FIG. 5 is a perspective view of a fragrance supplying module 200 for supplying fragrance into the drum 15 of the clothes dryer 10.

FIG. 4 shows the shape of the front supporter 28 viewed from the inside of the clothes dryer toward the front surface of the clothes dryer, and FIG. 5 shows the fragrance supplying module 200 of FIG. 4.

Referring to FIG. 4, a filter 25 is mounted below the front supporter 28, thereby filtering lint included in air discharged from the drum 15. The fragrance supplying module 200 is mounted at a side surface of the front supporter 28.

Referring to FIG. 5, the fragrance supply module 200 includes a fragrance injection unit 210, a fragrance storage unit 220 connected to the fragrance injection unit 210, a pump 230 connected to the fragrance storage unit 220, and a nozzle 250 connected to the pump 230 by a tube 240 for spraying fragrance into the drum 15.

The fragrance injection unit 210 is composed of a fixed member 210b and a slide member 210a. The fixed member 210b is fixedly-mounted to the front supporter 28, and the slide member 210a is slidably mounted to the fixed member 210b. Protrusions are formed on both side surfaces of the slide member 210a, and guide members for guiding the protrusions inserted thereto to perform a sliding motion. Accordingly, the slide member 210a may be inserted into the fixed member 210 by a sliding motion, thereby being inserted into the front supporter 28.

A discharge opening is formed at a lower part of the fixed member 210b, and is connected to the fragrance storage unit 220 through a pipe. Under this configuration, when a user is to inject a fragrant liquid into the fragrance storage unit 220, the slide member 210a of the fragrance injection unit 210 is pulled to be protruding from the fixed member 210b, i.e., the slide member 210a is made to be protruding from the front supporter 28. Then, the fragrant liquid is injected into the slide member 210a for supplement.

In the fragrance storage unit 220, may be disposed a level sensor 221 for measuring the amount of a fragrant liquid stored in the fragrance storage unit 220. The level sensor 221 may be an electrode sensor, or a reed switch operated by a magnetic field generated from a permanent magnet and a current-carrying coil. The present invention may be also provided with a means for informing a user that the amount of fragrance inside the fragrance storage unit 220 is not sufficient. Preferably, the means is installed at a control panel disposed on a front surface of the clothes dryer 10.

Hereinafter, a fragrance spraying step in the condensation-type clothes dryer 10 will be explained in brief. Once a user

Firstly, a user opens the door 24 to put laundry into the drum 15, and then inputs a drying course with fragrance spray through an input unit mounted on the control panel 14. As a result, water is supplied to the steam generator 100 through the water supplying hose 110, thereby being heated by a heater mounted in the steam generator 100. Then, steam generated from the steam generator 100 is introduced into the drum 15 through the steam nozzle 120.

Once the drying step starts, the driving motor 20 is operated. And, the belt 16 wound on an outer circumferential surface of the drum 15 and the motor shaft 21 is rotated as the motor shaft 21 is rotated. Accordingly, the drum 15 is also rotated. Here, the cooling fan 22 and the drying fan 19 connected to the driving motor 20 are together driven, and the heater 18 mounted in the drying duct 17 heats air introduced into the drum 15.

The steam generator 100 includes a case 150, and a heater mounted in the case 150 for heating water and converting the water into vapor. The water supplying hose 110 for supplying water is mounted at one side of the steam generator 100, whereas the discharge hole 120 for discharging the vapor evaporated from the inside of the steam generator 100 is mounted at another side of the steam generator 100. The steam nozzle 121 for spraying steam is mounted at the end of the discharge hose 120. The steam nozzle 121 is mounted at a front or rear side of the drum 15, thereby spraying steam into the drum 15. By the steam generator, water supplied by the water supplying hose 110 is heated by the heater to be converted into steam. Then, the generated steam is introduced into the drum 15 via the discharge hose 120 and the steam nozzle 121, thereby removing wrinkles occurring on the clothes during the drying step, and sterilizing the clothes.

In the fragrance spraying step of the present invention, fragrance may be sprayed into the drum of the clothes dryer while a steam spraying step is executed.

In the present invention, a fragrant liquid injected into the fragrance injection unit 210 of the fragrance supplying module 200 is stored in the fragrance storage unit 220. Then, the fragrant liquid is compressed by the pump 230 when necessary, thereby being sprayed into the drum 15 through the nozzle 250 in the form of mists. The time when the fragrant liquid is sprayed may be manually controlled by a user's manipulation of the control panel, or may be automatically controlled by a microprocessor. In the case of the latter automatic control, a user selects his or her desired drying course among a plurality of pre-programmed drying courses on the control panel. According to the selected drying course, the time to spray the fragrant liquid is automatically controlled by a microprocessor.

The fragrance spraying step according to the first embodiment of the present invention will be explained. Once clothes is introduced into the drum of the clothes dryer, the drying step starts. Then, the dried clothes undergoes a first fragrance spraying step of spraying fragrance into the drum of the clothes dryer while spraying steam into the drum of the clothes dryer. Then, it is judged by a controller of the clothes dryer whether the steam spraying step has finished. If the steam spraying step has finished, the clothes undergoes a second fragrance spraying step of re-spraying fragrance into the drum of the clothes dryer. Since the fragrance spraying step is divided into the first and second steps, may be enhanced a wrinkle removing step originally executed by the steam spraying step. Furthermore, fragrance is smoothly supplied to the clothes having not been completely dried thus to be in a wet state, the fragrance spraying step and the steam spraying step can be simultaneously executed.

The steam spraying step is executed for about 7 minutes. During the steam spraying step, rotation and stopping of the drum is periodically repeated. More concretely, during the steam spraying step, the drum 15 is rotated (tumbling) for about 3 seconds, and is stopped for a predetermined time. Again, the drum 15 is rotated for about 3 seconds and is stopped, which is repeatedly performed. The reason why the drum 15 repeats the rotation and stopping during the steam spraying step is in order to enhance a fragrance spraying effect as well as a steam spraying effect. Here, the time for which the drum 15 is rotated is preferably shorter than the time for which the drum 15 is stopped.

The first fragrance spraying step may be executed during the steam spraying step, or upon start of the steam spraying step. Also, the first fragrance spraying step may be executed several times during the steam spraying step. However, the second fragrance spraying step is executed after the steam spraying step has finished. By spraying fragrance into the clothes under a state that the clothes inside the drum has been completely dried, fragrance is supplied to the clothes. Preferably, the second fragrance spraying step is executed when an inner temperature of the drum 15 has been lowered to some degree as a predetermined time lapses after the steam spraying step has finished.

More concretely, under the control of the controller, a temperature measuring step of measuring an inner temperature of the drum is executed, and then the measured temperature is compared with a preset temperature. Only when the inner temperature of the drum 15 satisfies the preset temperature, fragrance may be sprayed into the drum 15. The second fragrance spraying step is executed when the measured temperature is lower than the preset temperature. Preferably, fragrance is sprayed to the clothes when the inner temperature of the drum 15 of the clothes dryer is 30° or 40° C. after the steam spraying step has finished. Preferably, the second fragrance spraying step towards the inside of the drum 15 is continuously executed for at least one minute.

Under these configurations, fragrance is firstly sprayed into the drum 15 of the clothes dryer 10 while steam is sprayed to the clothes during the drying step. Then, the fragrance is secondarily sprayed into the drum 15 of the clothes dryer 10 after the steam spraying step has finished. This may allow fragrance to be more effectively deposited onto the clothes inside the drum 15 of the clothes dryer 10, and may enhance a drying effect by steam.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A method for controlling fragrance spray for a clothes dryer, comprising:
a clothes inputting step of inputting an object to be dried into a drum of a clothes dryer;
a steam spraying step of spraying steam into the drum of the clothes dryer;
a first fragrance spraying step of spraying fragrance into the drum of the clothes dryer during the steam spraying step; and
a second fragrance spraying step of spraying fragrance into the drum of the clothes dryer after the steam spraying step has finished.

2. The method of claim 1, wherein in the steam spraying step, steam is continuously sprayed into the drum, and rotation and stopping of the drum is periodically repeated by a driving motor.

3. The method of claim 2, wherein when the drum is repeatedly rotated and stopped, time for which the drum is rotated is shorter than time for the drum is stopped.

4. The method of claim 1, wherein in the first fragrance spraying step, the fragrance is continuously sprayed for at least one minute.

5. The method of claim 2, wherein the first fragrance spraying step is executed upon start of the steam spraying step.

6. The method of claim 2, wherein the first fragrance spraying step is periodically executed during the steam spraying step.

7. The method of claim 1, wherein in the second fragrance spraying step, the fragrance is continuously sprayed for at least one minute.

8. A method for controlling fragrance spray for a clothes dryer, comprising:
a clothes inputting step of inputting an object to be dried into a drum of a clothes dryer;
a steam spraying step of spraying steam into the drum of the clothes dryer;
a first fragrance spraying step of spraying fragrance into the drum of the clothes dryer;
a temperature measuring step of measuring an inner temperature of the drum;
a temperature comparing step of comparing the measured temperature of the drum with a preset temperature; and
a second fragrance spraying step of spraying fragrance into the drum of the clothes dryer when the measured temperature is lower than the preset temperature.

9. The method of claim 8, wherein in the second fragrance spraying step, the fragrance is continuously sprayed for at least one minute

10. The method of claim 8, wherein the preset temperature is 40° C.

11. The method of claim 8, wherein the preset temperature is 30° C.
